(19) United States
(12) Patent Application Publication
(10) Pub. No.: US 2021/0201400 A1
(43) Pub. Date: Jul. 1, 2021

(54) INTELLIGENT SERVICING

(71) Applicant: LendingClub Corporation, San Francisco, CA (US)

(72) Inventors: Jianju Liu, Kentfield, CA (US); Jianglan Han, San Francisco, CA (US); Sandeep Tuppad Vijayakumar, Fremont, CA (US); Ali Nazari, Brisbane, CA (US); Ashish Thukral, San Francisco, CA (US); Ashutosh Pradeepkumar Raval, Sunnyvale, CA (US)

(21) Appl. No.: 16/728,356

(22) Filed: Dec. 27, 2019

(51) Int. Cl. G06Q 40/02; G06N 20/00; G06N 5/04

(52) U.S. Cl. CPC G06Q 40/025; G06N 5/04; G06N 20/00

(57) ABSTRACT

Techniques are described for predicting the likelihood that a loan default will occur. The technique can be performed pro-actively, in order to predict situations in which a loan default is likely even before any payment has been missed on the loan. Upon detecting a high likelihood of default, the loan default prediction system may automatically execute remedial actions. For example, the loan default prediction system may automatically generate an offer, to the borrower in question, to allow the borrower to skip the next loan payment. The technique may also be used to generate accurate financial health scores that take into account trends in a borrower's activities. The actions that are automatically performed based on the financial health scores may include both remedial actions and reward actions. The outcomes of the actions may be fed back into the system to further refine the model used thereby.

### FIELD OF THE INVENTION

The present invention relates to automated behavior prediction and, more specifically, to automatically predicting the likelihood that a loan default will occur.

### BACKGROUND

Often, the first hint that a loan default may occur is a late or missed payment on the loan. Unfortunately, that “hint” may come too late to take effective remedial measures to avoid the occurrence of the default. If a lender could be alerted to the likelihood of a loan default before any payment is missed, at least in some situations the default may be avoided.

The financial health of a borrower may also improve after a loan has been obtained. Under the improved conditions, the borrower may be entitled to additional credit or a lower interest rate. However, since the improvement came after obtaining the loan, the borrower is usually stuck with the terms obtained when the borrower's financial health was worse. Even in situations where the borrower is able to improve the terms of the loan based on improved financial help, the burden is typically on the borrower to realize and act upon the opportunity to negotiate improved terms.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram of a loan default prediction system 100, according to an embodiment;

FIG. 2 is a block diagram of a financial health prediction system 200, according to an embodiment; and

FIG. 3 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for predicting the likelihood that a loan default will occur. The technique can be performed pro-actively, in order to predict situations in which a loan default is likely even before any payment has been missed on the loan. Upon detecting a high likelihood of default, the loan default prediction system may automatically execute remedial actions. For example, the loan default prediction system may automatically generate an offer, to the borrower in question, to allow the borrower to skip the next loan payment.

Allowing the borrower to skip the next loan payment is merely one example of the remedial measures that may be triggered in response to detecting a high likelihood of default. The techniques described herein are not limited to any particular automated response.

In one embodiment, the machine learning engine is repeatedly trained to evolve its knowledge to determine the relevant characteristics for predicting default, test those characteristics, and test the effectiveness of the response to the triggers. The machine learning engine can detect potential default based on less obvious and more subtle issues than, for example, a missed payment. In one embodiment, information about each borrower is pulled each month. The information may, for example, indicate if they opened a new account or tradeline, measure income, and calculate ability to pay in a different way. Thus, the financial health prediction is made with a focus on capacity to pay. This is particularly useful to detect situations where the customer has been approved on solid ground, but things have evolved. In situations where a high likelihood of default is predicted, the lending can offer help for those who are struggling and offer a second loan if they are becoming financially healthy.

Techniques are also provided for generating a general “financial heath” score that reflects the current trend in the financial health of a user. In response to a drop in the financial health of a user, remedial actions may be automatically triggered. For example, if the system detects several large expenses at a place that a user usually does not spend money, then the system may determine that the cash flow of the user has changed in a way that won't recover. Under these circumstances, the system may automatically offer a skip payment. Conversely, in response to a rise in the financial health of a user, reward actions may be automatically triggered. The reward action may be, for example, the lowering of an interest rate on an outstanding loan and/or an increase in the maximum credit extended to the user.

### System Overview

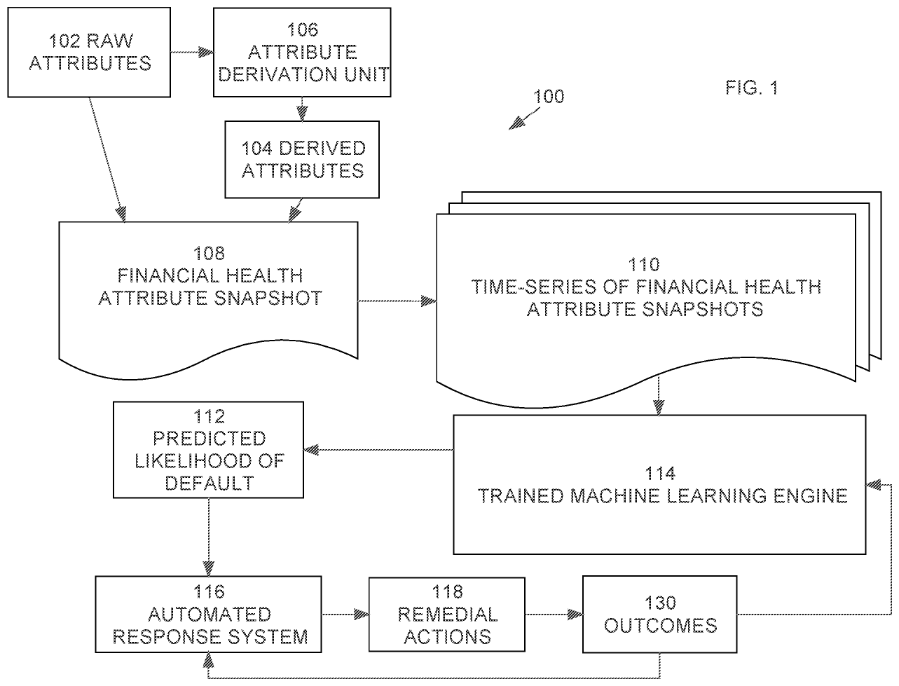

FIG. 1 is a block diagram of a loan default prediction system 100, according to an embodiment. Load default prediction system 100 includes a trained machine learning engine 114 that has been trained to output, for each given borrower, a predicted likelihood of default 112 based on a time-series of financial heath attribute (FHA) snapshots 110 for that given borrower.

The time-series of FHA snapshots 110 is a series of snapshots of financial health attributes, where each snapshot (e.g. snapshot 108) in the series contains attribute values that reflect the borrower's financial health at a given point in time. For example, time-series 110 may include 24 FHA snapshots, one for each month of the last two years. The amount of time between FHA snapshots in the time series 110 may vary from implementation to implementation. For example, a new FHA snapshot may be generated for a borrower on a daily, weekly, monthly, or annual basis.

In the illustrated embodiment, each FHA snapshot 108 includes values for raw attributes 102 and values for derived attributes 104. The raw attributes 102 may correspond to information, relating to the finances of the borrower in question, obtained from sources such as credit bureaus, banks, stores, lenders, etc.

Derived attributes 104, on the other hand, may correspond to information, relating to the finances of the borrower in question, that is derived from the raw attributes 102. Derived attributes may be, for example, scores generated by one or more credit models. The logic used to generate the derived attributes 104 from the raw attributes 102 is generally represented by attribute derivation unit 106, which may include one or more computing devices programmed to implement the one or more credit models.

Once a predicted likelihood of default 112 is generated by trained machine learning engine 114, the predicted likelihood of default 112 may be fed to an automated response system 116. Automated response system 116 may simply be logic that implements a set of rules. For example, in situations where the predicted likelihood of default 112 is greater than a threshold value, automated response system 116 may automatically cause one or more remedial actions 118 to be performed. For example, if the predicted likelihood of default 112 exceeds the threshold (meaning that the borrower in question is likely to default on a loan), the automated response system 116 may automatically send the borrower a message that gives the borrower the option to skip a payment on the loan. As another example, the automated response system 116 may simply generate an alert message. In response to such an alert message, a human operator may call the borrow to see how to best assist with the situation.

The remedial actions 118 triggered by automated response system 116 may vary from situation to situation. For example, instead of or in addition to offering to allow the user to skip a payment, the user may be presented with incentives to continue making payments, such as an offer to earn a bonus gift of $300 simply by making the next three payments on time. In addition to helping borrowers get through difficult times, such incentives also increase the likelihood that if the borrower is going to default on something, it would not be on the loan in question.

Automated response system 116 may itself be a machine learning engine that is trained to select the most effective remedial action based on the predicted likelihood of default and, optionally, some of the information from the time-series of FHA snapshots 110. In a machine learning engine embodiment, automated response system 116 may be trained based on historical data regarding the outcomes 130 produced by various types of remedial actions in prior situations.

Significantly, the time series of FHA snapshots of a borrower may be fed to trained machine learning engine 114 on a periodic basis before the borrower ever misses a payment on a loan. Because loan default is predicted before any payment is missed, remedial actions can be taken earlier, when the ability to avoid default is greater.

### Raw Attributes

As mentioned above, each FHA snapshot includes various raw attributes 102. The raw attributes 102 may be obtained from a variety of sources, including third-party sources, such as credit bureaus. If the system 100 is being operated by a lender, the raw attributes 102 will typically also include the borrower's history with the lender (payment history, loan terms, etc.). Examples of raw attributes 102 may include, for example:
Number of payments in last 3 months
Ratio of actual to minimum payment for revolving trades last month
Number of non-mortgage balance increases last 3 months
Number of deduped inquiries in past 6 months
Aggregate bankcard balances for month 1-month 24
Percentage of open revolving trades >75% of credit line verified in past 12 months
Aggregate non-mortgage balances for month 1-month 24
Number of credit card trades opened in past 6 months
Number of currently open and satisfactory credit card trades 6 months or older
Total credit line of open credit card trades verified in past 12 months

These are merely examples of the types of information that may be included in raw attributes 102. In practice, thousands of raw attributes may be included in each FHA snapshot. The techniques described herein are not limited to any particular set of raw attributes. Further, the raw attributes obtained from third party sources may change over time. Consequently, one FHA snapshot in a time-series may not have exactly the same raw attributes as another FHA snapshot in the same time series.

### Derived Attributes

As mentioned above, in attrition to raw attributes, each FHA snapshot may include derived attributes 104. Derived attributes 104 generally represent any attributes derived from the raw attributes 102. Derived attributes 104 may include, for example:
Desired loan amount to income ratio
Percentage of bankcard balances changed from previous 12 month average to month 1
Max number of month in a row within 24 months that aggregate non-mortgage balances increase
Ratio of total monthly payment for individual installment account to income
Average of aggregate bankcard balances for previous 24 months

In addition, attribute derivation unit 106 may include the logic of one or more credit models. For the purpose of explanation, it shall be assumed that attribute derivation unit 106 includes the logic for five generations (G1 to G5) of a credit model. The credit model for each generation takes the values of various raw attributes as input and, based on those values, generates a “credit score” for the borrower. Typically, different generations of a credit model will take different raw attributes as input and/or apply different weights to those raw attributes to derive a credit score for a user. Thus, even for the same user with the same raw attributes, the credit scores generated by each generation of credit model will be different. An example of the logic of a simple credit model is:

Credit Score=1/(1+exp (sum of ({credit_attributes}*{their corresponding weights})))

The input attributes and logic of the credit models may vary from generation to generation, so the credit scores generated the various credit model generations may also differ from generation to generation. In such an embodiment, any given FHA snapshot may include five different derived credit scores, one for each of the five generations of the credit model.

Significantly, the credit scores generated by credit models (G1 to G5) are not the only input into each FHA snapshot 108. Limiting an FHA snapshot 108 to the credit scores generated by credit models could adversely impact the accuracy of trained machine learning engine 114 because credit models are prohibited from taking into account some attributes that may be highly relevant to the question of whether a borrower will default on a loan. For example, credit models generally cannot account for the geographic location at which a borrower resides. However, if a certain city is undergoing a financial crisis, a borrower that lives in that city is more likely to default on a loan than similarly-situated borrowers in other cities. For example, if the primary source of employment for a small town is a company that recently failed, it is likely that many borrowers from that town will default on their loans. A borrower in that town may have a high likelihood of default simply because the borrower is from that town, even if the borrower has not yet missed any payments.

### Time-Series of FHA Snapshots

As mentioned above, each FHA snapshot (e.g. FHA snapshot 108) contains values for the raw attributes 102 and the derived attributes 104 of a borrower at a particular point in time. Thus, each FHA snapshot is associated with a particular point in time or time period. Because a FHA snapshot corresponds to a single point or period of time, a single snapshot alone cannot reflect whether the borrower's financial situation is improving or getting worse.

Consequently, rather than attempting to generate a predicted likelihood of default 112 based on a single FHA snapshot, trained machine learning engine 114 is trained to generate the predicted likelihood of default 112 based on an entire time series of FHA snapshots (e.g. time-series 110). Each FHA snapshot in the time-series of FHA snapshots 110 is for (a) the same borrower, but (b) distinct points/periods of time. For example, each FHA snapshot in time series 110 may be for Tom Smith, but for a different month of the last 24 months. Consequently, when generating the predicted likelihood of default 112, trained machine learning engine 114 accounts for not simply the current state of a borrower's financial health, but also accounts for trends that have occurred during the period covered by the time-series of FHA snapshots 110.

### Training the Machine Learning Engine

As mentioned above, trained machine learning engine 114 is trained to generate a predicted likelihood of default 112 based on a time-series of FHA snapshots 110 for a given borrower. Once trained, the machine learning engine 114 is able to determine the attribute profile of good loans based on vintage or point in time, and determine the attribute profile of bad loans based on vintage or point in time.

Trained machine learning engine 114 may be implemented in a variety of ways. According to one embodiment, a neural network is trained using historical information of actual prior borrowers. For example, historical information may be used to generate a time-series of FHA snapshots for hundreds or thousands of prior borrowers. For each of those prior borrowers, the trained machine learning engine 114 may be fed (a) the time-series of FHA snapshots for the borrower, and (b) and indication of whether the borrower defaulted on a loan. Based on this input (the “training set”), the machine learning engine 114 builds a model. After the model is built on the training set, the model may be used to generate the predicted likelihood of default for borrows that have not yet defaulted (and may have not even missed any payments).

After the trained machine learning engine 114 is initially trained, the model used by the trained machine learning engine 115 may be further refined based on new data. For example, the outcomes 130 of remedials action 118 may be gathered. In some cases, the remedial actions 118 may have prevented default, while in other cases loan default may have occurred despite the remedial actions 118. In either case, the trained machine learning engine 114 may be further trained by feeding the time-series of FHA snapshots of the borrowers to the trained machine learning engine 114 along with the corresponding outcomes 130 (e.g. loan default or no loan default).

### Automated Response System

As mentioned above, automated response system 116 receives the predicted likelihood of default 112 and, based on the likelihood of default, may automatically cause performance of one or more remedial actions 118. The complexity of automated response system 116 may vary from implementation to implementation. For example, in a simple implementation, automated response system 116 simply compares the predicted likelihood of default to a threshold value, and if the likelihood exceeds the threshold, causes generation of a warning message. A human user may respond to the warning message by calling the borrowing in question to see if help is needed.

In a more complex embodiment, automated response system 116 is able to trigger any one of a variety of remedial actions, where the remedial action that is triggered is based on the likelihood of default. For example, a likelihood between a first threshold and a second threshold may trigger a warning, while a likelihood greater than the second threshold may trigger both a warning and cause a message to be sent to the borrower that offers to allow the borrower to skip a payment.

Automated response system 116 may itself include a trained machine learning engine that has been trained to select a remedial action based on the predicted likelihood of default. Such a machine learning engine may be trained based on historical information about predicted likelihood of defaults, the remedial actions taken, and their corresponding outcomes. In such an embodiment, information from the FHA snapshots may be fed to the machine learning engine (along with the corresponding likelihood prediction, remedial action, and outcome), so that the machine learning engine will be trained to pick the remedial action that is most likely to produce a positive outcome (e.g. avoid loan default) under the circumstances indicated by the FHA snapshots and the predicted likelihood of default.

### Intelligent Servicing System

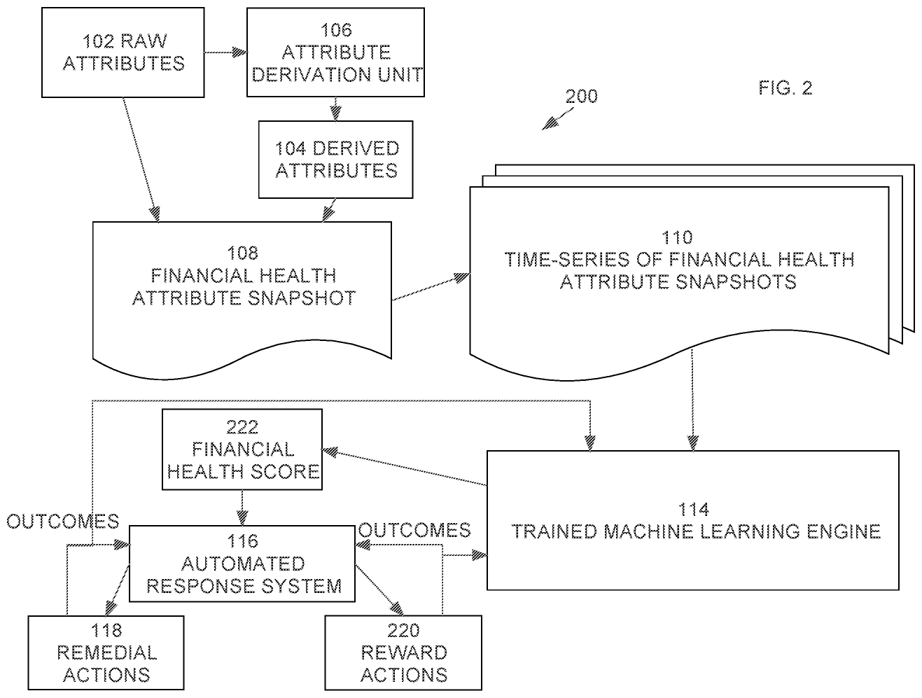

FIG. 2 is a block diagram of an intelligent servicing system 200, according to an embodiment. Intelligent servicing system 200 is similar to loan default prediction system 100 except that, rather than merely predict the likelihood that a borrower will default on a loan, intelligent servicing system 200 generates financial health scores 222 that predict the future financial health of a user. In such an embodiment, the automated response system 116 is configured to select one or more remedial actions 118 in situations where the financial health score 222 is below a threshold, and to select a reward action 220 when the financial health score 222 is above a different threshold.

The remedial actions 118 may vary from situation to situation. For example, in some situations the automated response system 116 may send the user an offer to allow the user to skip a payment. As another example, the automated response system 116 may send the user with a revised payment plan that imposes less of a burden on the user than the user's current payment plan. The actual remedial action 118 selected by automated response system 116 may be based on the severity of the situation, as indicated by the financial health score 222.

Similarly, the reward actions 220 may vary from situation to situation. As one example, a positive financial health score 222 may cause automated response system 116 to issue to the corresponding user an offer to lower the interest rate of an existing loan. As another example, a positive financial health score 222 may cause automated response system 116 to pass the borrower's data to a credit model (which, unlike trained machine learning engine 114, does not take into account any attributes, such as zip code, for which there are regulatory restrictions). Based on the score generated by the credit model, the automated response system 116 may issue to the corresponding user an offer for an additional loan, or an offer to increase the cap of an existing credit line.

In one embodiment, the reward action may be in the form of a “Do this, Get that!” message. In such a message, a specific reward is indicated (e.g. the lowering of the interest rate of a loan, or receiving a gift card) for performance of a specific action (e.g. making the next three loan payments on time). Such “Do this, Get that!” messages may be used both as reward actions 220 and remedial actions 118 since they increase the incentive for the user not to miss a payment. These are merely examples of types of reward actions 220 a positive financial health score 222 may cause automated response system 116 to perform. The techniques described herein are not limited to any particular types of reward actions 220.

As with loan default prediction system 100, the outcomes of the remedial actions 118 and reward actions 220 may be fed back into the trained machine learning engine 114, along with the corresponding time-series of FHA snapshots, to further refine the model used by the trained machine learning engine 114 based on the newly-obtained outcome data. In embodiments where the automated response system 116 is a machine learning engine, the newly-obtained outcome data may also be used to train the automated response system 116 with respect to which remedial actions 118 are most effective (and which reward actions 220 are most effective).

It should be noted that the outcomes that are fed back into machine learning engine 114 and automated response system 116 are not limited to whether or not the user in question defaulted on the loan in question. For example, the outcomes could extend to other information obtained about the user's behavior after the reward actions 220 and/or remedial actions 118. For example, the outcome information may include whether the user is “favoring” one lender over another. An indication that a user favors one lender over another may be, for example, that the user always makes payments to one lender on time, while payments to other lenders may sometimes be late or missed. As another example, the outcome information may indicate that the user prefers one source of funding over another. Such is the case, for example, when a user charges nearly all purchases to one credit card even though the user has many credit cards.

### Loan Default Prediction as a Service

Knowledge of the predictions/scores generated by systems 100 and 200 may be valuable to third parties. For example, system 100 need not be operated by a lender to determine the likelihood of default of the loans the lender has made. Instead, system 100 may be operated by a third party, and made available as a service to any lender that is interested in determining the likelihood that borrowers may default on their loans. In such an embodiment, an API may be provided whereby the third-party lenders transmit information, for each of their loans, information about the loan and the corresponding borrower. Some of the provided information may be submitted as raw attributes 102, while other information (e.g. the identity of the borrower) may be used as the key to pull information (e.g. credit reports) from other sources such as credit bureaus. Some of the raw attributes thus obtained may be used to generate derived attributes, as explained above. The information is fed to trained machine learning engine 114 and, for each loan, the predicted likelihood of default 112 (from system 100) and/or the financial health score 222 (from system 200) may be provided back to the third-party lender.

In such an embodiment, the response generated by automated response system 116 may also be provided as a recommendation to the third-party lender. Alternatively, the third-party lender may have their own system for deciding how to respond to the information obtained from systems 100 and 200. For example, in response to a prediction that there is a high likelihood of loan default even though no payment has been missed, a third-party lender may purchase loan default insurance for the loan.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

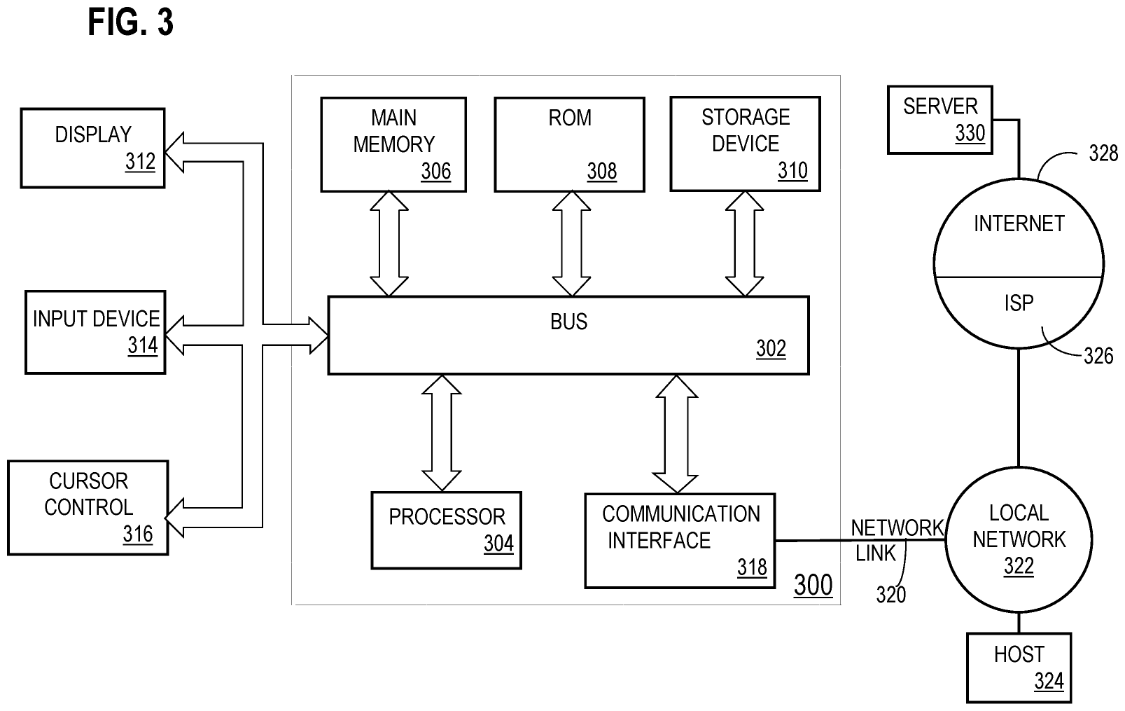

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312.

This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
creating a sequence of snapshots by, for each time period of a plurality of time periods, obtaining a snapshot of values of financial health attributes of a user;
wherein each snapshot in the sequence of snapshots contains values, for financial health attributes of the user, that correspond to the respective time period associated each snapshot;
feeding the sequence of snapshots to a trained machine learning engine to cause the trained machine learning engine to generate a score; and
based at least in part on the score, automatically performing one or more actions;
wherein the method is performed by one or more computing devices.

2. The method of claim 1 wherein each snapshot, of the sequence of snapshots, includes one or more raw financial health attributes and one or more derived financial health attributes.

3. The method of claim 2 wherein the one or more derived financial heath attributes of each snapshot include at least:
a first credit score generated by a first generation of a credit model based on values for a first set of raw attributes; and
a second credit score generated by a second generation of the credit model based on values for a second set of raw attributes.

4. The method of claim 3 wherein the second set of raw attributes includes one or more raw attributes that are not in the first set of raw attributes.

5. The method of claim 1 wherein the score is a predicted likelihood of default for a particular loan.

6. The method of claim 1 wherein the score is a financial health score that is based, at least in part, on trends reflected in the sequence of snapshots.

7. The method of claim 1 wherein performing one or more actions includes performing a remedial action.

8. The method of claim 7 wherein the remedial action includes one or more of:
offering the user an opportunity to skip a payment on a loan; or
offering the user an opportunity to change one or more payment terms on the loan.

9. The method of claim 1 wherein performing one or more actions includes performing a reward action.

10. The method of claim 1 wherein performing one or more actions includes feeding the score into an automated response system configured to determine the one or more actions to be performed based on the score.

11. The method of claim 10 wherein the automated response system includes a second trained machine learning engine.

12. The method of claim 11 further comprising:
obtaining information about outcomes achieved after performing the one or more actions; and
revising a model used by the second trained machine learning engine based, at least in part, on the outcomes achieved after performing the one or more actions.

13. The method of claim 1 further comprising:
obtaining information about outcomes achieved after performing the one or more actions; and
revising a model used by the trained machine learning engine based, at least in part, on the outcomes achieved after performing the one or more actions.

14. The method of claim 1 wherein at least one financial health attribute in the series of snapshots is an indication of a geographic location of the user.

15. The method of claim 1 wherein the trained machine learning engine is trained based on sequences of snapshots for a first set of prior borrowers that did not default on their respective loans and sequences of snapshots for a second set of prior borrowers that did default on their respective loans.

16. One or more non-transitory computer-readable media storing instructions which, when executed by one or more computing devices, cause:
creating a sequence of snapshots by, for each time period of a plurality of time periods, obtaining a snapshot of values of financial health attributes of a user;
wherein each snapshot in the sequence of snapshots contains values, for financial health attributes of the user, that correspond to the respective time period associated each snapshot;
feeding the sequence of snapshots to a trained machine learning engine to cause the trained machine learning engine to generate a score; and
based at least in part on the score, automatically performing one or more actions.

17. The one or more non-transitory computer-readable media of claim 16 wherein each snapshot, of the sequence of snapshots, includes one or more raw financial health attributes and one or more derived financial health attributes.

18. The one or more non-transitory computer-readable media of claim 16 wherein the score is a predicted likelihood of default for a particular loan.

19. The one or more non-transitory computer-readable media of claim 16 wherein the score is a financial health score that is based, at least in part, on trends reflected in the sequence of snapshots.

20. The one or more non-transitory computer-readable media of claim 16 wherein performing one or more actions includes feeding the score into an automated response system configured to determine the one or more actions to be performed based on the score.

21. The one or more non-transitory computer-readable media of claim 20 wherein the automated response system includes a second trained machine learning engine.

22. The one or more non-transitory computer-readable media of claim 21 further comprising instructions for:
obtaining information about outcomes achieved after performing the one or more actions; and
revising a model used by the second trained machine learning engine based, at least in part, on the outcomes achieved after performing the one or more actions.

23. The one or more non-transitory computer-readable media of claim 16 further comprising instructions for:
obtaining information about outcomes achieved after performing the one or more actions; and
revising a model used by the trained machine learning engine based, at least in part, on the outcomes achieved after performing the one or more actions.

24. The one or more non-transitory computer-readable media of claim 16 wherein at least one financial health attribute in the series of snapshots is an indication of a geographic location of the user.

25. The one or more non-transitory computer-readable media of claim 16 wherein the trained machine learning engine is trained based on sequences of snapshots for a first set of prior borrowers that did not default on their respective loans and sequences of snapshots for a second set of prior borrowers that did default on their respective loans.
